(19) United States
(12) Patent Application Publication
(10) Pub. No.: US 2004/0139615 A1
(43) Pub. Date: Jul. 22, 2004

(54) Hair trimming device

(76) Inventor: Charles Gianatasio, Boca Raton, FL (US)

Correspondence Address: David L. Principe, Hodgson Russ LLP, One M&T Plaza, Suite 2000, Buffalo, NY, 14203-2391, US

(21) Appl. No.: 10/348,243

(22) Filed: Jan. 21, 2003

(51) Int. Cl. B26B 13/22

(52) U.S. Cl. 30/233; 30/123; 30/233.5

(57) ABSTRACT

A hair trimming device with a trimmer having at least one oscillating blade and at least one fixed blade. The trimmer has an enclosure supporting the blades and containing an electric motor. A spirit level is rigidly secured to the trimmer such that a visual indication of a horizontal position is provided to a user during operation of the trimmer.

### BRIEF DESCRIPTION OF THE DRAWINGS

The invention is illustrated in the drawings in which like reference characters designate the same or similar parts throughout the figures of which:

FIG. 1 is a front elevational view of the hair trimming device of the present invention;

FIG. 2 is a left side elevational view of the hair trimming device shown in FIG. 1;

FIG. 3 is a right side elevational view of the hair trimming device shown in FIG. 1;

FIG. 4 is a sectional view of the spirit level of the present invention taken along lines 4-4 of FIG. 1;

FIG. 5 is a side elevational view of the spirit level of FIG. 4.

FIG. 6 is a front elevational view of an alternate embodiment of the present invention; and, FIG. 7 is a partial side elevational view taken along line 7-7 of FIG. 6.

### DETAILED DESCRIPTION

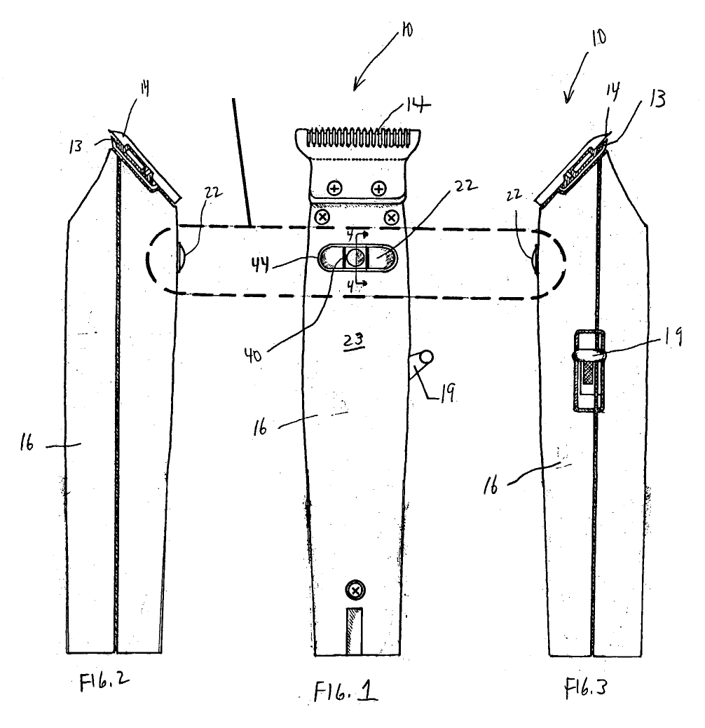

As shown in FIGS. 1-3, the hair trimming device of the present invention includes a trimmer 10 of the type having oscillating blades 13 that move back and forth across a set of fixed blades 14 to provide a scissors-type shearing action at the cutting surface. The trimmer 10 is typically provided with an electric motor (not shown) that is powered by 110V AC. As an alternative, the trimmer may be powered by batteries (not shown). The batteries may be disposable or rechargeable.

The electric trimmer 10 is provided with an enclosure 16. The electric motor and controls are disposed inside the enclosure 16. A switch 19 is provided on the side of the enclosure 16. The switch 19 controls the flow of electricity from the power source to the electric motor controls.

A spirit level 22 is rigidly mounted on the electric trimmer 10 to indicate the angle at which a cut is being made relative to the horizontal. In the example shown, a spirit level 22 provides a visual indication of the orientation of the hair trimmer 10 with respect to the horizontal.

The spirit level 22 is positioned in the front surface 23 of enclosure 16 at a position near the end of the enclosure 16 where the blades 13 and 14 are located. The spirit level 22 is positioned adjacent the blades 13 and 14 so that the user can make a visual observation of the position of the spirit level 22 while trimming hair.

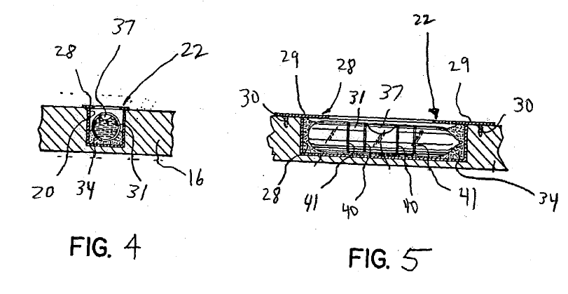

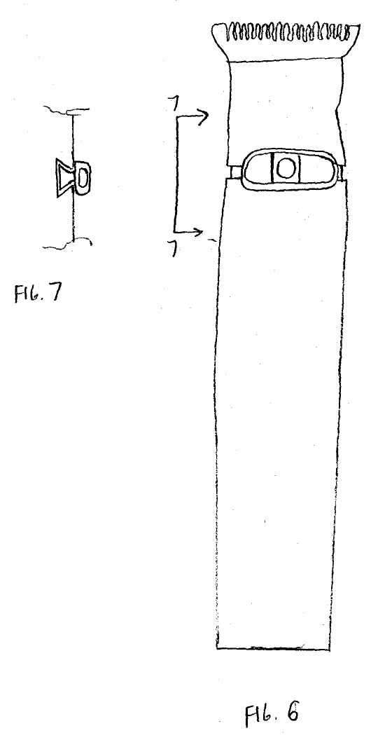

Turning to FIGS. 4 and 5, the spirit level 22 consists of a small housing 28 in which is fixed a level-tube 31 held in a fixed position by putty or plastic 34, or any other suitable means. The tube 31 is fluid-tight and filled usually with alcohol or ether with a small bubble of air 37 trapped inside the tube. The tube 31 has a pair of vertical lines 40 where the bubble 37 will indicate an exact horizontal position when the bubble 37 is exactly spaced between them. Additional lines 41 may be provided to indicate the angle of a cut based on the position of the bubble 37.

The spirit level 25 is fixed in the enclosure 16 by providing a recess into which the housing 28 fits. A seal 44 (FIG. 1) may be provided around the edges of the opening for the spirit level 22. As shown, the housing 28 may be provided with structural members 29 extending from opposite sides for attaching the housing 28 to the area surrounding the recess by means of screws 30 Other means for mounting the housing 28 inside the enclosure 16 will be apparent to those of ordinary skill in the art.

Turning to FIG. 6, in an alternate embodiment of the invention, a spirit level 100 is mounted on a track 103 that is disposed on the enclosure 16. The spirit level 100 may be provided in an enclosure 106 having a tongue or groove capable of engaging with a cooperating tongue or groove member comprising the track 103. Accordingly, the spirit level 100 can be moved to different locations on the enclosure where it can be viewed more easily. As will be evident to those of ordinary skill in the art, the spirit level 100 may be retained in different positions along the track 103 by friction or other locking means.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A hair trimming device, comprising:
a trimmer having at least one oscillating blade and at least one fixed blade, and an enclosure supporting the blades and containing an electric motor; and, a spirit level rigidly secured to the trimmer such that a visual indication of a horizontal position is provided to a user during operation of the trimmer.

2. The hair trimming device of claim 1, wherein the spirit level is attached to the enclosure.

3. The hair trimming device of claim 1, further comprising a recess disposed in the enclosure.

4. The hair trimming device of claim 3, wherein the spirit level is disposed within the recess.

5. The hair trimming device of claim 1, wherein the trimmer is powered by 110V AC power.

6. The hair trimming device of claim 1, wherein the trimmer is battery powered.

7. The hair trimming device of claim 1, wherein the enclosure has a track disposed thereon.

8. The hair trimming device of claim 7, wherein the spirit level is movable on the track.

9. A hair trimming device, comprising:
a trimmer having a plurality of oscillating blades, a plurality of fixed blades, and an enclosure having a front surface, the enclosure supporting the blades and housing an electric motor; and,
a spirit level rigidly secured to the trimmer at a position on the front surface adjacent the blades such that a visual indication of a horizontal position is provided to a user during operation of the trimmer.

10. The hair trimming device of claim 9, wherein the spirit level is attached to the enclosure.

11. The hair trimming device of claim 9, further comprising a recess disposed in the enclosure.

12. The hair trimming device of claim 11, wherein the spirit level is disposed within the recess.

13. The hair trimming device of claim 9, wherein the trimmer is powered by 110V AC power.

14. The hair trimming device of claim 9, wherein the trimmer is battery powered.

15. The hair trimming device of claim 9, wherein the enclosure has a track disposed thereon.

16. The hair trimming device of claim 9, wherein the spirit level is movable on the track.
